(19) United States
(12) Patent Application Publication
(10) Pub. No.: US 2011/0083071 A1
(43) Pub. Date: Apr. 7, 2011

(54) METHOD FOR DISPLAYING STRING OF BASIC INPUT OUTPUT SYSTEM

(75) Inventors: Ying-Chih Lu, Taipei City (TW); Yu-Hui Wang, Taipei City (TW)

(73) Assignee: INVENTEC CORPORATION, Taipei City (TW)

(21) Appl. No.: 12/617,980

(22) Filed: Nov. 13, 2009

(30) Foreign Application Priority Data
Oct. 1, 2009 (TW) 98133401

(51) Int. Cl. G06F 3/048; G06F 17/00

(52) U.S. Cl. 715/255; 715/764

(57) ABSTRACT

A method for displaying strings of basic input output system (BIOS) is provided. In the present invention, a BIOS storage unit includes a first globally unique identifier (GUID), a default string area, and an overriding string area with a second GUID. The first GUID and the second GUID are read from the BIOS storage unit to determine whether the second GUID is equal to the first GUID under executing the BIOS. The overriding string data read from the overriding string area is displayed, if the second GUID is equal to the first GUID. Oppositely, the default string data read from the default string area is displayed, if the second GUID is not equal to the first GUID.

### CROSS-REFERENCE TO RELATED APPLICATION

This application claims the priority benefit of Taiwan application serial no. 98133401, filed on Oct. 1, 2009. The entirety of the above-mentioned patent application is hereby incorporated by reference herein and made a part of specification.

### BACKGROUND OF THE INVENTION

1. Field of the Invention

The present invention relates to a method for displaying strings. More particularly, the present invention relates to a method for displaying strings of a basic input output system (BIOS).

2. Description of Related Art

In a computer system, a basic input output system (BIOS) plays an important role. When the computer system is activated, the BIOS is first booted to executed a power on self test (POST) to initialize-peripheral hardware devices.

Generally, a text of the BIOS can only be unchangeably displayed on the screen. According to a conventional method, only source codes of the BIOS can be changed, and the changed source codes are written into a BIOS storage unit. Users cannot adjust strings and attributes (including a foreground color and a background color) of the BIOS according to their favourites and demands.

### SUMMARY OF THE INVENTION

The present invention is directed to a method for displaying strings of a basic input output system (BIOS), by which an overriding string area is added in a BIOS storage unit to display an overriding string data recorded in the overriding string area.

The present invention provides a method for displaying strings of a BIOS. In the present invention, first, the BIOS stored in a BIOS storage unit is executed. The BIOS storage unit includes a first globally unique identifier (GUID), a default string area and an overriding string area. The overriding string area is used to store a second GUID and an overriding string data. Next, the first GUID and second GUID are read from the BIOS storage unit. And then it is determined whither the second GUID is equal to the first GUID. If the second GUID is equal to the first GUID, the overriding string data is read from the overriding string area to displaying. Oppositely, if the second GUID is not equal to the first GUID, the default string data is read from the default string area to displaying.

In an embodiment of the present invention, the method for displaying the strings further includes writing the overriding string data in the overriding string area, which includes providing an overriding text file including the overriding string data; converting the overriding text file into an overriding binary file; and writing the overriding binary file into the overriding string area.

In an embodiment of the present invention, the method for displaying the strings further includes editing the overriding string data in the overriding string area, which includes converting the overriding string data into an overriding text file and editing the overriding text file; and converting the edited overriding text file into an overriding binary file, and writing it in the overriding string area.

In an embodiment of the present invention, the method for displaying the strings further includes updating the default string data in the default string area according to a renew text file, wherein the renew text file includes a third GUID. In detail, the overriding string data is first converted into an overriding text file. Next, it is checked whether the third GUID is equal to the first GUID, and a version of the renew text file is determined unsuitable for the BIOS if the third GUID is not equal to the first GUID. Next, it is checked whether the third GUID is equal to the second GUID if the third GUID is equal to the first GUID. If the third GUID is not equal to the second GUID, a string identification of the overriding text file is converted according to the renew text file, and the third GUID is written into the overriding string area.

In an embodiment of the present invention, the overriding string area includes a header and a body, wherein the header is used for recording the second GUID, a signature, a length and a checksum, and the body is used for recording the overriding string data including a string name, a string identification, a string content and a string attribute.

In an embodiment of the present invention, the method for displaying the strings further includes clearing the overriding string data in the overriding string area.

According to the present invention, an overriding string area is added in the BIOS storage unit, so that the user can directly update the string data in the overriding string area under an operating system (OS), which is quite convenient. Therefore, the user can quickly customize the strings and attributes of the BIOS according to the aforementioned method, so that a displayed frame thereof can present a personal style, which avails increasing a value-added of the product.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a BIOS storage unit according to an embodiment of the present invention.

FIG. 2 is a flowchart illustrating a method for displaying strings according to an embodiment of the present invention.

FIG. 3 is a flowchart illustrating a method for updating strings according to an embodiment of the present invention.

### DESCRIPTION OF THE EMBODIMENTS

Generally, strings displayed by a basic input output system (BIOS) are all default values, and a user cannot adjust the strings and attributes of the BIOS according to his/her favourite and demand. Accordingly, the present invention provides a method for displaying strings of the BIOS, by which an overriding string area is added in a BIOS storage unit, so that the user can directly update string data in the overriding string area under an operating system (OS). In order to make the aforementioned and other features and advantages of the present invention comprehensible, several exemplary embodiments accompanied with figures are described in detail below.

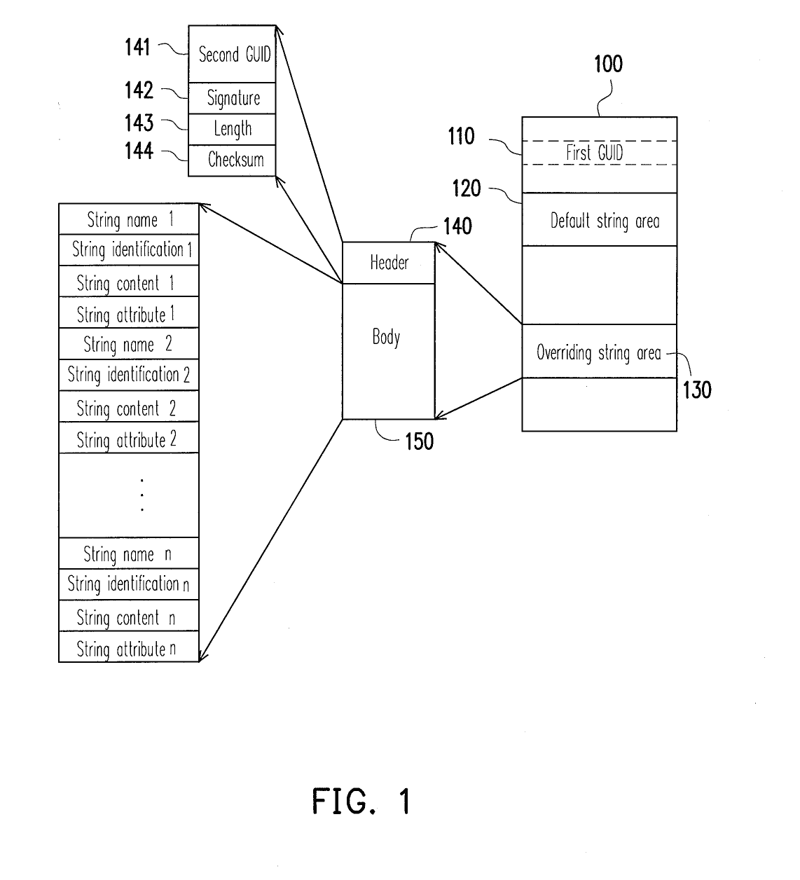

FIG. 1 is a schematic diagram illustrating a BIOS storage unit according to an embodiment of the present invention. Referring to FIG. 1, the BIOS storage unit 100 is, for example, a flash read only memory, which includes a first globally unique identifier (GUID) 110, a default string area 120 and an overriding string area 130.

Generally, a BIOS storage unit only has a default string area. However, in the present embodiment, besides the first GUID 110 and the default string area 120, the BIOS storage unit 100 further includes the overriding string area 130. The default string area 120 is used for storing a default string data of the BIOS, and the overriding string area 130 is used for storing overriding string data of the BIOS to replace the default string data for displaying.

In the present embodiment, the overriding string area 130 includes a header 140 and a body 150. The header 140 records a second GUID 141, a signature 142, a length 143 of the body 150, and a checksum 144, while the body 150 records a plurality of sets of overriding string data, wherein a data structure of each sets of the overriding string data includes a string name, a string identification, a string content and a string attribute. Here, the first GUID 110 and the second GUID 141 are 16 bytes.

The string attribute includes a foreground color and a background color. For example, assuming the string attribute is 8 bits, 4 bits (for example, 0-3) are used to control the foreground color, and the other 4 bits (for example, 4-7) are used to control the background color. For example, the bits 0, 1 and 2 are respectively used to control three colors of blue, green and red of the foreground, and the bit 3 is used to control a brightness of the foreground, while the bits 4, 5 and 6 are respectively used control the three colors of blue, green and red of the background, and the bit 7 is used to control a brightness of the background.

Accordingly, since the overriding string area 130 is added to the BIOS storage unit 100, the users can edit the overriding string data in the overriding string area 130 by themselves. Based on the BIOS storage unit 100, another embodiment is provided to describe detailed steps of the method for displaying the strings.

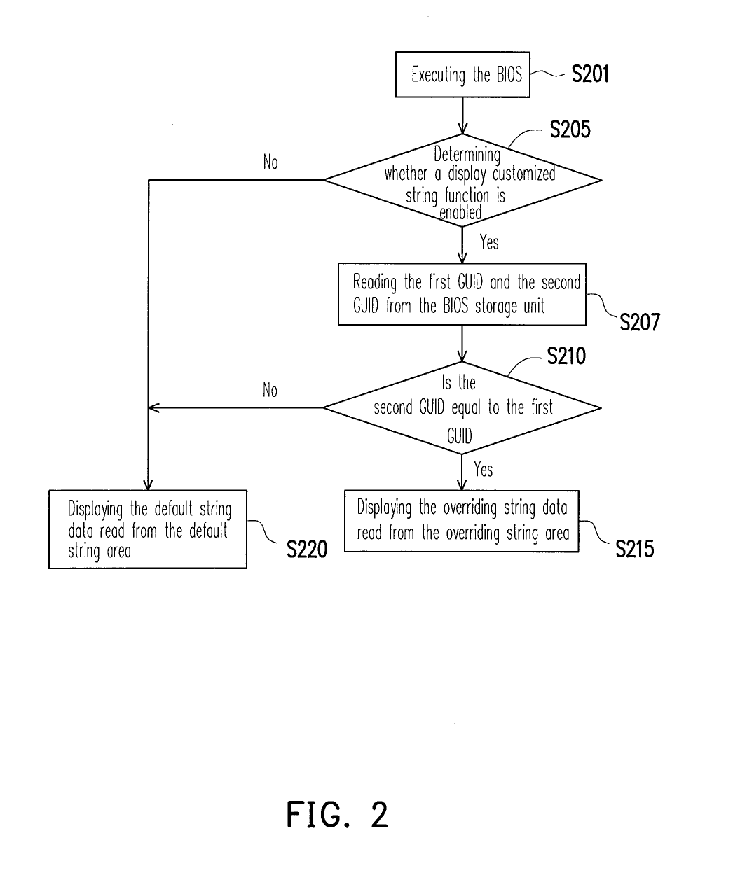

FIG. 2 is a flowchart illustrating a method for display strings according to an embodiment of the present invention. Referring to FIG. 1 and FIG. 2, in a step S201, the BIOS is executed. Next, in a step S205, it is determined whether a display customized string function is enabled, so as to determine whether the overriding string data is used to replace the default string data for displaying. For example, a function option can be set in a menu of the BIOS to enable the display customized string function.

If the display customized string function is not enabled, as shown in step S220, the default string data read from the default string area is displayed. Oppositely, if the display customized string function is enabled, as shown in a step S207, the first GUID 110 and the second GUID 141 are read from the BIOS storage unit 100. Next, in a step S210, it is determined whether the second GUID 141 is equal to the first GUID 110, so as to determine whether the overriding string data in the overriding string area 130 is suitable for the BIOS to use. If the second GUID 141 is not equal to the first GUID 110, it represents that the overriding sting data in the overriding string area is not suitable for the BIOS, as shown in a step S220, the default string data read from the default string area 120 is displayed. Conversely, if the second GUID 141 is equal to the first GUID 110, it represents that the overriding sting data in the overriding string area is suitable for the BIOS, as shown in a step S215, the overriding string data read from the overriding string area 130 is displayed according to each of the string identifications in the overriding sting area 130.

In detail, if the second GUID 141 is equal to the first GUID 110, it is verified whether the signature 142 and the checksum 144 in the header 140 are invalid. If the signature 142 and the checksum 144 are all correct, the corresponding overriding string data is obtained and displayed according to the string identification in the body 150. If the signature 142 and the checksum 144 are incorrect, the step S220 is executed to display the default string data read from the default string area 120.

Here, an overriding text file can be provided for writing in the overriding string area 130 in advance. The overriding text file includes the overriding string data. After the overriding text file is converted into an overriding binary file, the overriding binary file can be written in the overriding sting area 130. Moreover, the default string data in the default string area 120 can also be converted into a text file for modification, so as to obtain the above overriding text file.

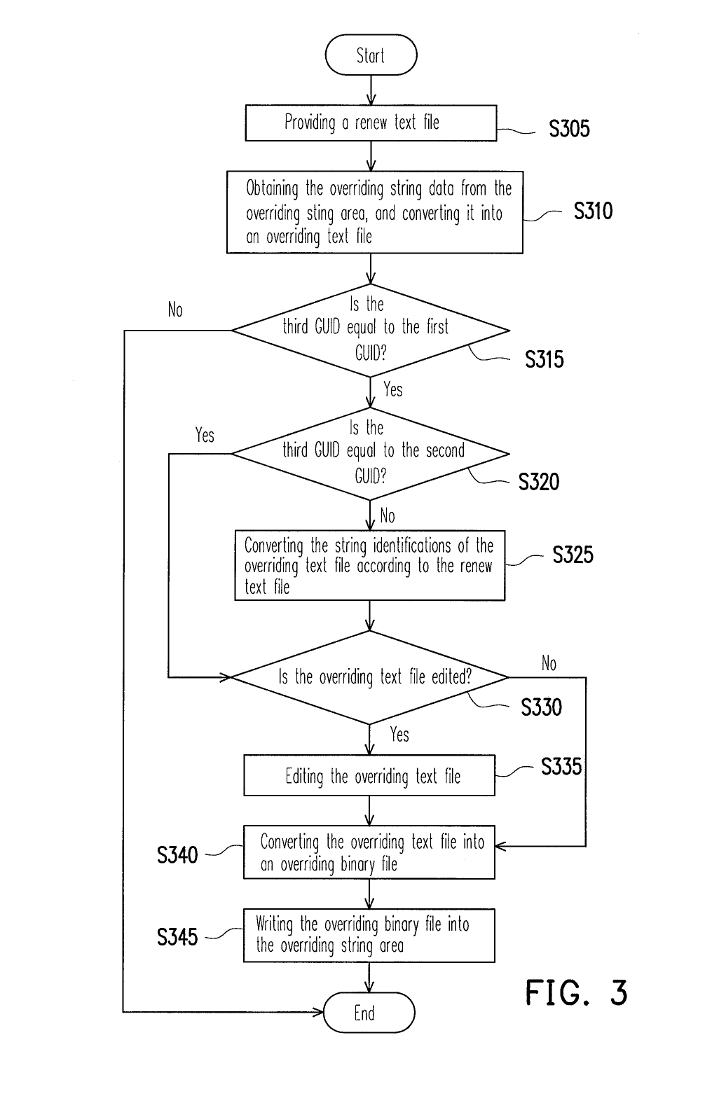

It should be noticed that in the present embodiment, the overriding string data in the overriding string area 130 can be further updated. FIG. 3 is a flowchart illustrating a method for updating strings according to an embodiment of the present invention. Referring to FIG. 1 and FIG. 3, in a step S305, a renew text file (When BIOS binary code is produced, also will produce this renew text file at the same time) including a third GUID is provided. When a BIOS binary code is created, the renew text file is created. The renew text file includes a third GUID. Next, in a step S310, all of the overriding string data is obtained from the overriding sting area 130, and the overriding string data is converted into an overriding text file.

Next, in a step S315, it is checked whether the third GUID is equal to the first GUID 110, so as to determined whether a version of the renew text file is correct. If the third GUID is not equal to the first GUID 110, it represents that the version of the renew text file is incorrect, so that the operation flow is ended, and a message of incorrect version can further be indicated. Conversely, if the third GUID is equal to the first GUID 110, a step S320 is executed to check whether the third GUID is equal to the second GUID 141, so as to determine whether the overriding text file is not suitable for the BIOS when the renew text file is updated to the default string area.

If the third GUID is not equal to the second GUID 141, it represents that the overriding text file is not suitable for the updated BIOS to use after the renew text file is updated to the default string area 120. Next, in a step S325, the string identifications of the overriding text file are converted according to the renew text file.

For example, assuming the overriding text file is “Cpu_Speed, 0002h, Current CPU Speed, 41h”, wherein “Cpu_Speed” represents the string name, 0002h represents the string identification, “Current CPU Speed” represents the string content, and 41h represents the string attribute. Moreover, assuming the renew text file is “Cpu_Speed, 0001h, Current Processor Speed, 14h”, wherein “Cpu_Speed” represents the string name, 0001h represents the string identification, “Current Processor Speed” represents the string content, and 14h represents the string attribute.

The string identifications of the above overriding text file and the renew text file are different, so that after the renew text file is updated to the default string area 120, the overriding string data in the overriding string area 130 probably cannot be normally displayed. Therefore, in the step S325, the string identification of the overriding text file is converted according to the string name, so that the string identifications of the overriding text file and the renew text file can be the same, and the third GUID is written into the overriding text file. The converted overriding text file is “Cpu_Speed, 0001h, Current CPU Speed, 41h”. On the other hand, if the third GUID is equal to the second GUID 141, conversion of the string identification in the overriding text file is unnecessary.

Next, in a step S330, it is determined whether the overriding string data in the overriding string area is edited. If yes, a step S335 is executed, and if not, a step S340 is executed.

In the step S335, the overriding text file is edited according to the renew text file. For example, any edit tool can be used to edit the overriding text file. After the overriding text file is edited, in the step S340, the overriding text file is converted into an overriding binary file. Finally, in a step S345, the overriding binary file is written into the overriding string area 130.

Moreover, an erasing function can further be set in the menu of the BIOS for erasing the overriding string data in the overriding string area 130 when a power on self test (POST) or display of the BIOS has an error due to the overriding string area 130.

In summary, in the present invention, an overriding string area is added in the BIOS storage unit for the user to modify the strings of the BIOS according to his/her demand. Therefore, according to the aforementioned method, the user can directly update the string data in the overriding string area under an operating system, so as to quickly customize the strings and the attributes of the BIOS, so that a displayed frame thereof can present a personal style, which avails increasing a value-added of the product.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying strings of a basic input output system (BIOS), comprising:
executing the BIOS stored in a BIOS storage unit, and the BIOS storage unit comprising a first globally unique identifier (GUID), a default string area and an overriding string area, wherein the default string area is used to store a default string data of the BIOS, and the overriding string area includes a second GUID and the overriding string data of the BIOS;
reading the first GUID and second GUID from the BIOS storage unit;
determining whither the second GUID is equal to the first GUID;
displaying the overriding string data read from the overriding string area if the second GUID is equal to the first GUID; and
displaying the default string data read from the default string area if the second GUID is not equal to the first GUID

2. The method for displaying the strings of the BIOS as claimed in claim 1, further comprising writing the overriding string data in the overriding string area, which comprises:
providing an overriding text file comprising the overriding string data;
converting the overriding text file into an overriding binary file; and
writing the overriding binary file into the overriding string area.

3. The method for displaying the strings of the BIOS as claimed in claim 1, further comprising:
editing the overriding string data in the overriding string area.

4. The method for displaying the strings of the BIOS as claimed in claim 3, wherein the step of editing the overriding string data in the overriding string area comprises:
converting the overriding string data into an overriding text file, and editing the overriding text file; and
converting the edited overriding text file into an overriding binary file, and writing it in the overriding string area.

5. The method for displaying the strings of the BIOS as claimed in claim 1, further comprising:
updating the overriding string data in the overriding string area according to a renew text file, wherein the renew text file comprises a third GUID.

6. The method for displaying the strings of the BIOS as claimed in claim 5, wherein the step of updating the overriding string data in the overriding string area comprises:
converting the overriding string data into an overriding text file;
checking whether the third GUID is equal to the first GUID to determine whether a version of the renew text file is suitable for the BIOS;
checking whether the third GUID is equal to the second GUID if the third GUID is equal to the first GUID; and
determine the version of the renew text file is not suitable for the BIOS if the third GUID is not equal to the first GUID.

7. The method for displaying the strings of the BIOS as claimed in claim 6, wherein after the step of checking whether the third GUID is equal to the second GUID, further comprising:
a string identification of the overriding text file is converted according to the renew text file if the third GUID is not equal to the second GUID, and the third GUID is written into the overriding text file.

8. The method for displaying the strings of the BIOS as claimed in claim 1, wherein the overriding string area comprises a header and a body, wherein the header is used for recording the second GUID, a signature, a length and a checksum, and the body is used for recording the overriding string data.

9. The method for displaying the strings of the BIOS as claimed in claim 1, wherein the overriding string data comprising a string identification, a string attribute, a string content, and a string name.

10. The method for displaying the strings of the BIOS as claimed in claim 1, further comprising:
erasing the overriding string data in the overriding string area.
